(19) United States
(12) Patent Application Publication
(10) Pub. No.: US 2017/0211781 A1
(43) Pub. Date: Jul. 27, 2017

(54) LIGHT EMITTING DISPLAYS THAT SUPPLEMENT OBJECTS

(71) Applicant: SUN INNOVATIONS, INC., FREMONT, CA (US)

(72) Inventors: Xiao-Dong Sun, Fremont, CA (US); Leonard P. Sun, Fremont, CA (US)

(73) Assignee: SUN INNOVATIONS, INC., FREMONT, CA (US)

(21) Appl. No.: 15/411,342

(22) Filed: Jan. 20, 2017

Related U.S. Application Data
(60) Provisional application No. 62/281,693, filed on Jan. 21, 2016.
(60) Provisional application No. 62/312,746, filed on Mar. 24, 2016.
(60) Provisional application No. 62/434,928, filed on Dec. 15, 2016.

(51) Int. Cl. F21V 9/08; G02B 27/20

(52) U.S. Cl. CPC F21V 9/08; G02B 27/20

(57) ABSTRACT

An apparatus, system, and/or method that integrates excitable light emitting materials (that are transparent) into any surface to display an image. Light emitting materials may be integrated into uneven, irregular, and/or random surfaces, displays may be formed on objects that are not practical for flat panel displays (e.g. steering wheels). Light emitting materials may be integrated onto or into the surface of a flat panel display that is responsive to excitation light of a laser pointer, thus allowing flat panel displays to be more effectively used in presentation applications. Since the light emitting materials are transparent, application of light emitting materials into objects does not obstruct the view of the objects when the light emitting materials are not being used to display images.

This U.S. Patent Application claims priority to U.S. Provisional Patent Application No. 62/281,693 filed on Jan. 21, 2016, U.S. Provisional Patent Application No. 62/312,746 filed on Mar. 24, 2016, and U.S. Provisional Patent Application No. 62/434,928 filed on Dec. 15, 2016, which are hereby incorporated by reference herein in their entireties.

### BACKGROUND

Cathode ray tube (CRT) televisions and display monitors are the first mass marketed personal display devices. Flat panel displays revolutionized the display industry by offering customers high quality images on displays with desirably thin physical dimensions (as compared to CRTs) and larger screen sizes. Although flat panel displays are relatively thin compared to CRT displays, the current commercial flat panel displays are not transparent and will block or affect the view of the object behind the display screen. Since flat panel displays are not transparent with fixed screen aspect ratio, their applications are limited. For example, a flat panel display must be placed in a stationary position that does not obstruct the view of other objects.

Unlike a projection screen, CRTs and flat panel displays (e.g. liquid crystal displays, organic LED (OLED) displays, plasma displays, LED displays, etc.) cannot be easily highlighted using laser pointers or similar optic devices. Fiat panel displays are often used as presentation monitors in business, educational, or other community events. When a user targets a laser pointer beam at a specific position on a flat panel display for the purposes of highlighting the content output from the flat panel display, the light of the laser pointer is mostly absorbed and/or otherwise dispersed such that the intended highlighting by the user is not easily visible on the flat panel display, especially in lighted environments. This limits the applications and/or utility of flat panel displays as presentation projectors, since presenters often desire to highlight presentation content using a laser pointer or similar device.

Flat panel displays are limited to applications on flat surfaces that require some depth for supporting electronics. For example flat panel displays cannot be placed over an object surface, without blocking or affecting the original view of the surface. For example, it is not practical to integrate such a display into the surface of a steering wheel of an automobile, because surfaces of steering wheels are not normally flat. Steering wheels also do not have the available depth to absorb the relatively bulky electronics of a flat panel display. Consequentially, it is not practical to integrate graphical user interfaces using flat panel displays integrate into uneven, irregular, and/or random surfaces (e.g. the surface of a steering wheel). While flat panel displays can be made to be curved or even rollable, the same issue of visual and physical hinderness exist to display onto an arbitrary object surface.

### SUMMARY

Embodiments relate to excitable light emitting materials that are substantially transparent and may be integrated onto or into any surface to display an emissive image. Since in embodiments, light emitting materials may be integrated into uneven, irregular, and/or random surfaces, emissive displays may be formed on objects that are not practical for rigid flat panel displays with fixed aspect ratio (e.g. steering wheels). In embodiments, light emitting materials may be integrated onto or into the surface of a flat panel display that is responsive to excitation light of a laser pointer and emit a highly visible emission on the laser pointer spot, thus allowing flat panel displays to be more effectively used in presentation applications, without hiding or affecting the display image behind the emitting material. Since the light emitting materials are transparent by nature and remains largely transparent in use, application of light emitting materials into objects does not obstruct the view of the objects behind the light emitting materials.

### DRAWINGS

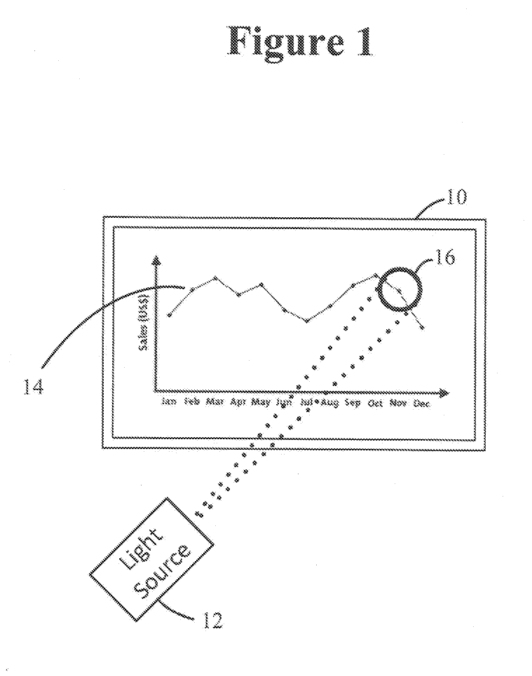

Example FIG. 1 illustrates a flat panel display image being highlighted by light emitting materials excited by a light source, in accordance with embodiments.

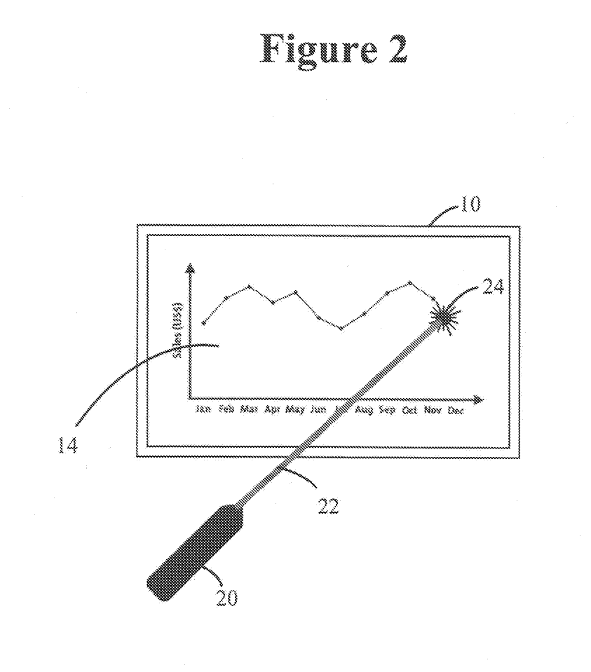

Example FIG. 2 illustrates a flat panel display image being highlighted by light emitting materials excited by a laser pointer, in accordance with embodiments.

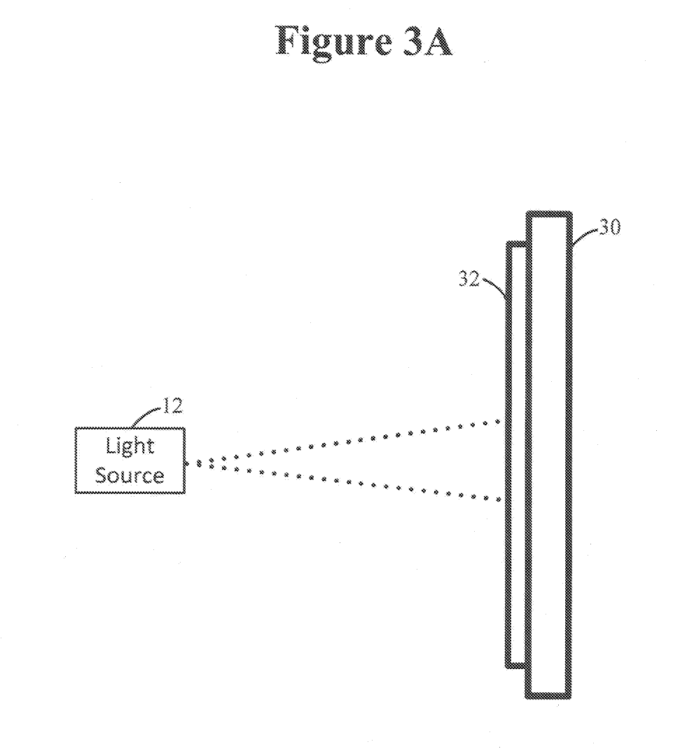

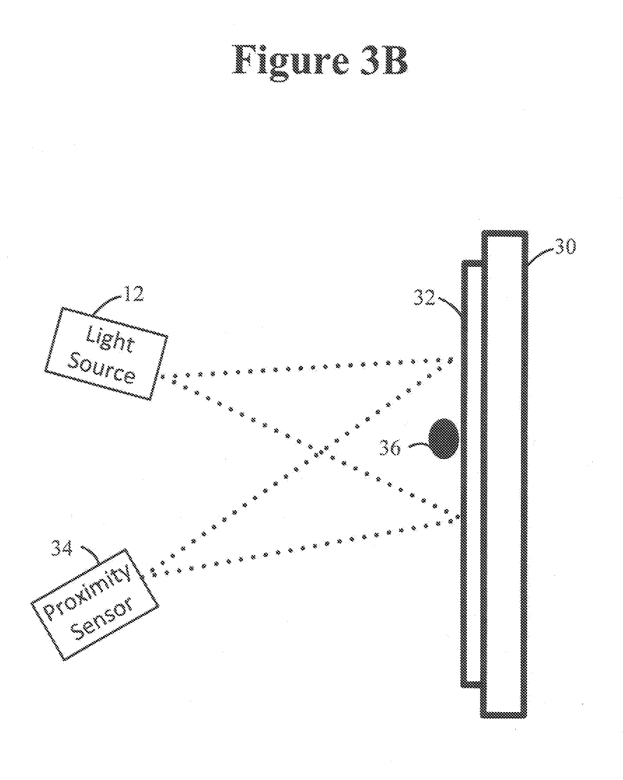

Example FIG. 3A illustrates a substrate integrated with light emitting materials excited by a light source, in accordance with embodiments.

Example FIG. 3B illustrates a substrate integrated with light emitting materials excited by a light source operating in conjunction with a proximity sensor, in accordance with embodiments.

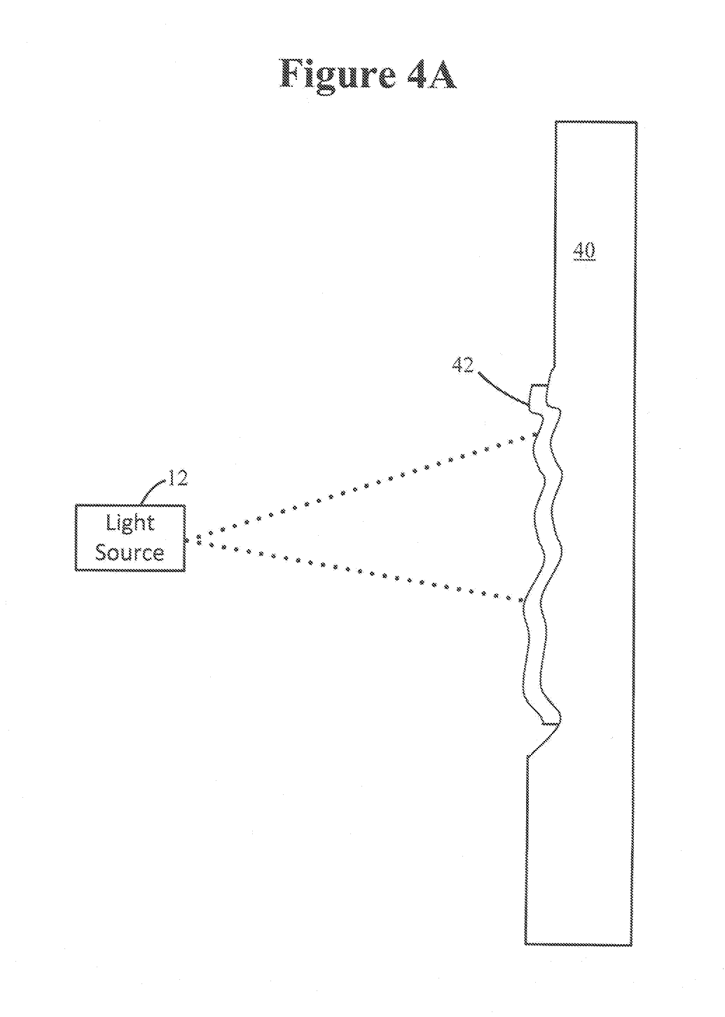

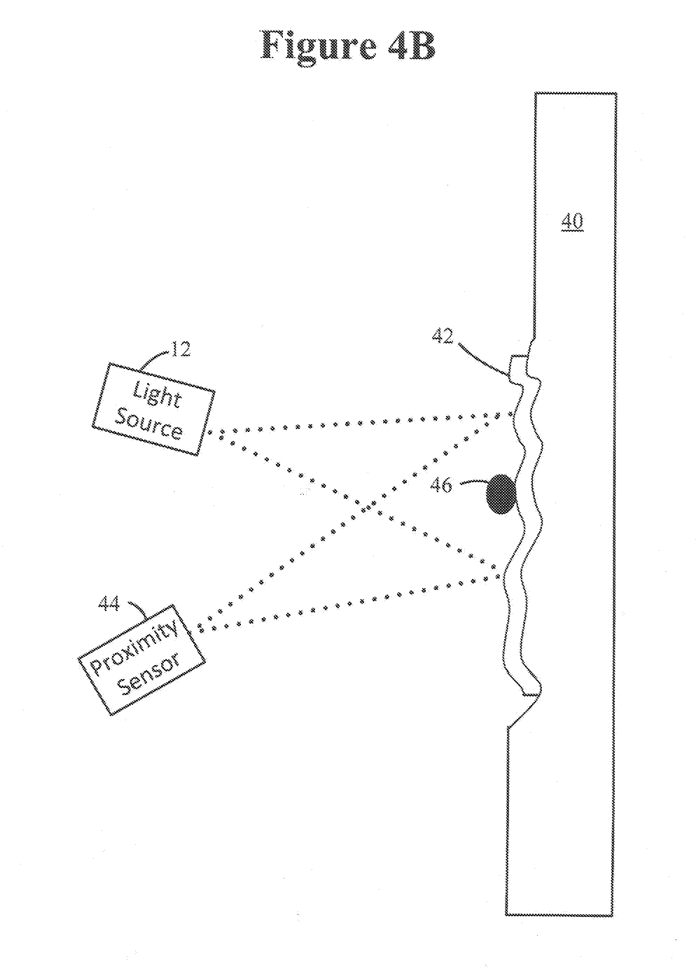

Example FIG. 4A illustrates an uneven, irregular, and/or random surface integrated with light emitting materials excited by a light source, in accordance with embodiments.

Example FIG. 4B illustrates an uneven, irregular, and/or random surface integrated with light emitting materials excited by a light source operating in conjunction with a proximity sensor, in accordance with embodiments.

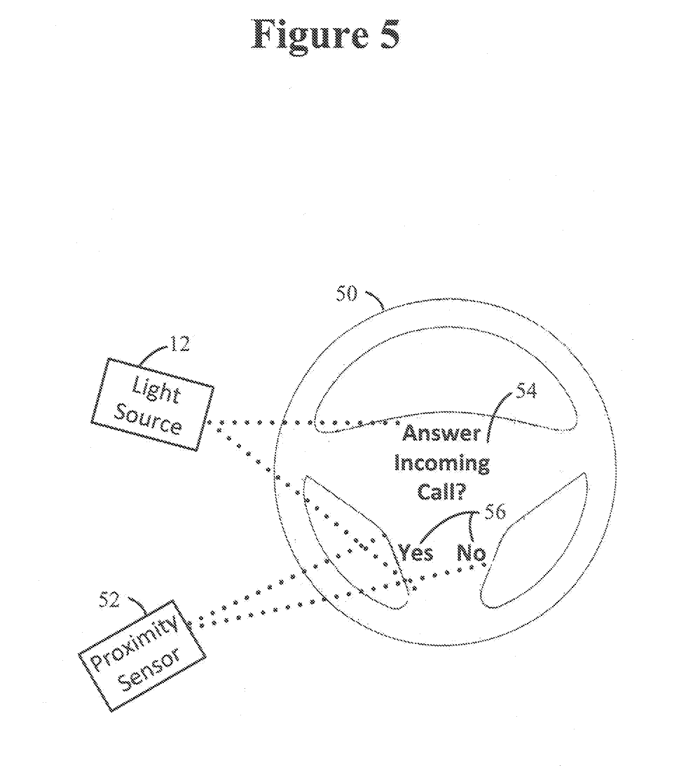

Example FIG. 5 illustrates a graphical user interface on an uneven, irregular, and/or random surface (e.g. a steering wheel) integrated with light emitting materials excited by a light source operating in conjunction with a proximity sensor, in accordance with embodiments.

### DESCRIPTION

Embodiments relate to a system including a light source, a physical medium, and light emitting material integrated into at least a portion of the surface of the physical medium. The light emitting material may be configured to emit visible light in response to absorption of ultraviolet light and/or visible light from the light source. The light emitting material may include a plurality of light emitting particles and/or molecules. Each of the plurality of light emitting particles may have a diameter less than about 500 nanometers. The surface of the physical medium is an object on which an image can be displayed by the emitted visible light in response to the light source. In embodiments, the light source is a laser pointer and the surface is at least a portion of a display device.

In embodiments, the display device may output an image which is independent of the visible light emitted in response to absorption of ultraviolet and/or visible light from the laser pointer. In embodiments, the light source is an ultraviolet and/or visible light projector. In embodiments, the light source is a laser pointer. A user of the laser pointer may annotate, supplement, and/or highlight the content output from the display device.

In embodiments, the uneven surface, the irregular surface, or the random surface is included on a surface of a vehicle. For example the surface of the vehicle may be a gage cluster of a vehicle, a transparent cover separated from instruments of the vehicle, a steering wheel, a mirror, a flat panel display, instruments, windows, and/or any other surface of any object (not limited to vehicles) on which light emitting particles can be integrated therein with little or no visual effects on the original surface. In embodiments, the visible light emitted at higher wavelengths in response to absorption of ultraviolet or visible light at lower wavelengths from the light source comprises a display of a graphical user interface.

Example FIG. 1 illustrates a flat panel display 10 displaying an image 14, in accordance with embodiments. For example, flat panel display 10 may display image 14 of a sales graph in a business presentation. A portion of the image 14 may be highlighted (e.g. circle mark 16) by the aiming by a user of the light source 12 at the particular portion of image 14 that the user desires to highlight, in accordance with embodiments. In embodiments, highlighting by a user on flat panel display 10 may be accomplished by light emitting materials integrated onto the surface of the flat panel display 10 which are excited by a light source 12. Since the light emitting materials are transparent and/or partially transparent, or translucent that still allows the view through the emitting materials with physical contact to the display surface, a user may highlight image 14 on flat panel display 10 independent of the display of the content generated by the flat panel display 10.

In embodiments, transparent emissive films may be used to enable a laser pointer or an interactive device on a flat panel display, including liquid crystal display (LCD), organic LED (OLED), LED displays, plasma display, rear-projection displays, electroluminescent display, and/or other similar devices. Example flat panel displays may have dark display screen, which have relatively good image quality compared to projection display screens. However, they do not support the use of optic highlighting or interactive devices such as laser pointer for multiple reasons. For example, black or dark flat panels may not reflect or deflect a laser pointer beam well like a white or silver projection screen, to show the laser pointer spot. As another example, while a high power laser pointer beam may be visible on the flat panel screen at some reflection angles, there will be safety concerns. As yet another example, high energy radiation like laser beam pointers may penetrate and damage the interior materials of the flat panel displays.

Embodiments relate to an optic highlighting method that may enable the use of laser pointer in any dark or black flat panel display screens, in conference rooms, class rooms, show room, broadcast or control rooms, and/or among many flat panel displays applications when a presenter uses a laser pointer on a flat panel screen. Embodiments may be built into a controller to control the display and/or built into a remote control, which can also highlight the display on the flat panel display screen.

In embodiments, the display device may be a flat panel display, an LCD display, an OLED display, a quantum dot display, a CRT display, a television, a monitor, a heads up display, and/or any other type of display.

Embodiments relate to applying a front layer of substantially transparent fluorescent materials onto a flat panel display screen. The layer of fluorescent materials may be either a coating or film with fluorescent materials, in accordance with embodiments. To make the screen substantially transparent, the fluorescent materials may include small inorganic phosphor particles, organic dyes, fluorescent small molecules and/or polymers, fluorescent quantum dots, and/or organo-metallic molecules that include fluorescent emitters such as rare earth cations, in accordance with embodiments. In embodiments, the median fluorescent particle or molecule sizes of the fluorescent materials are under 1000 nm. In embodiments, the median fluorescent particle or molecule sizes of the fluorescent materials are under 500 nm. In embodiments, the median fluorescent particle or molecule sizes of the fluorescent materials are under 100 nm. In embodiments, the median fluorescent particle or molecule sizes of the fluorescent materials are minimized to minimize visible light scattering. Embodiments may utilize polymer resins (e.g. such as those embodiments described above) including acrylics, polycarbonates, PMMA, polyurethane which may be utilized as a binder, a host, and/or a substrate of the fluorescent materials.

In embodiments, to reduce the possible laser reflectance, the surface of the fluorescent screen may be coated by anti-reflective coating, anti-glare coating, and/or the top film/coating surface may be textured to be matt or flat finish. In addition to the top surface, the fluorescent materials may be directly applied or integrated to the interior of flat panel displays during the manufacturing process of the flat panel displays, to add the function of the fluorescent layer for laser pointing devices, in accordance with embodiments.

In embodiments, a layer of substantially transparent fluorescent materials may be coated onto a flat panel display screen. Substantially transparent fluorescent materials may be permanently coated by resin or adhesive or can be applied using coating or films with permanent (e.g. pressure sensitive adhesive, and/or PSA), and/or removable (e.g. electrostatic, self-wetting, low tack, or silicone based adhesive), in accordance with embodiments. Some soft polymer film (e.g. vinyl) may be directly applied and adhered to the display surface. Due to its transparent nature, an original digital image may present to viewers with unnoticeable or very minimal change, in accordance with embodiments. A laser power of proper wavelength (e.g. UV, violet, or blue colors) may be used onto the fluorescent layer to excite the fluorescent emission from the coating or film, showing the laser pointer on the flat panel screen, in accordance with embodiments. Other optic devices of proper wavelength output may also be used to interact with the layer of the transparent emissive materials to interact with or control the display by sensing the laser spot on the screen, in accordance with embodiments.

Transparent fluorescent films or coatings, under a UV and/or blue ray (405 nm) pointer excitation, showing Red, Green, Blue, and white emission, in accordance with embodiments. In embodiments, all types of visible emissive colors may be generated.

In embodiments, multiple layers of transparent emissive films or layers may be applied to the display screen as either one layer or multiple layers. Laser pointers and/or other optic devices of multiple wavelengths may be used to generate emissive laser spots of various colors, using selective excitation of various fluorescent materials by various wavelengths, in accordance with embodiments. A laser pointer on a LCD monitor coated by a layer of transparent blue or red emissive materials, using a 5 mW blue ray (405 nm) laser pointer. As a comparison, a visible (blue) laser power of the same power (5 mW) is irradiated directly onto the LCD screen without the layer of fluorescent materials. While the blue laser spot is hardly visible on the uncoated flat panel screen, the lower lumen blue-ray laser (405 nm) pointer of the same 5 mW output shows brilliant blue or red emissive spots on the transparent emissive films in ambient light, as a comparative example. In this example, the blue ray laser beam may be mostly absorbed by the layer of the fluorescent film, which also protects the flat panel display materials from being damaged by the laser pointer. The fluorescent film may also block any harmful high energy radiation of the flat panel display from coming out, in accordance with embodiments.

In embodiments, the fluorescent materials may be applied in an adhesive of a polymer film. A fluorescent polymer film or polymer film with the fluorescent adhesive may have other functional top coatings such as anti-reflective, anti-glare, anti-smudge or fingerprints, anti-scratch, hard protective coatings, and/or other similar coatings, in accordance with embodiments. A fluorescent polymer film may be combined with a touch film and/or other interactive module to support the interactive display, in accordance with embodiments.

Example FIG. 2 illustrates a flat panel display image 14 being highlighted by light emitting materials excited by a laser pointer 20, in accordance with embodiments. In embodiments, transparent and/or substantially transparent light emitting materials may be integrated into and/or onto the display surface of flat panel display 10. The light emitting materials at the surface of flat panel display may independently emit fight responsive to excitation light 22 generated from laser pointer 20, in accordance to embodiments Similar to example FIG. 1, flat panel display 10 generates image 14. In embodiments, laser pointer 20 outputs excitation light 22 focused at a particular position of flat panel display 10 to generate mark 24 that highlights a portion of image 14. Mark 24 may be a visible pattern of light that is emitted from the light emitting materials at the flat panel display 10, in accordance with embodiments. In embodiments, excitation light 22 is used as an energy source to selectively excite the light emitting materials to control the generation of mark 24 image on the surface of flat panel display 10 which is independent of image 14 generated by flat panel display 10. Mark 24 may be any pattern or shape generated by a laser pointer 20 or other type of light source. Embodiments are not limited to laser pointers. In embodiments, excitation light may be ultraviolet light. Embodiments relate to excitation light outside of the ultraviolet range.

Example FIG. 3A illustrates a substrate 30 integrated with light emitting materials 32 excited by a light source 12, in accordance with embodiments. Although example FIG. 3A illustrates light emitting materials 32 formed as a film or layer on substrate 30, embodiments relate to any integration of light emitting materials or light emitting particles into and/or onto any surface. In embodiments, light emitting materials may be formed on an outside layer of an object by any practical deposition technique. In embodiments, light emitting materials may be formed in an intermediary layer at a surface of an object. In embodiments, light emitting materials may be at least partially absorbed at a surface of an objection. In embodiments, light source 12 may be any kind of light source that generates excitation light to which light emitting materials 32 are responsive. Embodiments are not limited by that illustrated in FIG. 3A.

In embodiments, the light emitting material is fluorescent material. In embodiments, the light emitting material includes a first material which emits a first visible color and a second material which emits a second visible color, which is different from the first visible color. In embodiments, the light emitting material comprises a third material which emits a third visible color, which is different from the first visible color and the second visible color.

In embodiments, the substrate 30 has relatively high visible light absorption characteristics (e.g. a dark screen). In embodiments, the substrate 30 has relatively low visible light absorption characteristics (e.g. mirror). In embodiments, the substrate 30 is substantially dark (e.g. a LCD screen). In embodiments, the substrate 30 is opaque (e.g. a steering wheel). In embodiments, the substrate 30 is substantially transparent (e.g. transparent glass). Embodiments are not limited to a flat substrate as illustrated in example FIG. 3A and embodiments include substrates or surfaces in substitution for substrate 30 which are uneven, irregular, and/or random surfaces or substrates.

Other than transparent fluorescent screen, embodiments include partially-transparent or even optically hazy films that contain bigger size inorganic phosphors or organic fluorescent pigments or dyes, in contact, with some optic coupling, or in close proximity to the flat panel display screen, which may also show the display image through the fluorescent film. Embodiments include the use of a “see-through” fluorescent film or coating on a flat panel display screen with low visual blocking effects to the display, which can absorb and convert the laser beam from a pointer or other optic interactive devices to fluorescent emission on the flat panel screen.

Example FIG. 3B illustrates a substrate 30 integrated with light emitting materials 32 excited by a light source 12 operating in conjunction with a proximity sensor and/or a photo sensor 36, in accordance with embodiments. In embodiments, an image generated by light emitting materials may be used as a graphical user interface using proximity sensor 34. A user element 36 (e.g. a human finger) may come in contact or in substantial proximity contact with an image generated by light emitting materials 32, in accordance with embodiments. In embodiments, proximity sensor 34 may detect the presence and/or approximate location of user element 36 and receive that detection as user feedback in conjunction with the image displayed by light emitting materials 32. Embodiments am not limited to those illustrated in example FIG. 3B and include any use of a proximity sensor with light emitting materials at any surface or substrate. A photo sensor or camera may also be used to detect and trigger display response on the emissive materials, in accordance with embodiments.

In embodiments, a proximity sensor may be coupled to a light source to allow feedback from a user movement in relation to the visible light emitted in response to the absorption of ultraviolet and/or lower wavelength visible light from the light source. In embodiments, the visible light emitted in response to absorption of ultraviolet and/or lower wavelength visible light from the light source comprises a display of a graphical user interface.

Example FIG. 4A illustrates an uneven, irregular, and/or random surface 40 integrated with light emitting materials 42 excited by a light source 12, in accordance with embodiments. Light emitting materials 42 may be integrated in any disclosed or practical fashion into or into a surface which is not flat (e.g. a steering wheel). In embodiments, since images displayed by light emitting materials can be displayed on non-flat surfaces (e.g. uneven, irregular, and/or random surfaces), display applications are possible which are not practical for flat panel displays.

In embodiments, a surface may be an uneven surface, an irregular surface, and/or a random surface. An image may be displayed on an uneven surface, an irregular surface, and/or a random surface by emitting visible light in response to absorption of ultraviolet light from a light source.

Example FIG. 4B illustrates an uneven, irregular, and/or random surface 40 integrated with light emitting materials 42 excited by a light source 12 operating in conjunction with a proximity sensor 44, in accordance with embodiments. In embodiments, a non-flat surface (e.g. surface 40) may be used as a graphical user interface with proximity sensor 44 able to detect user element 46 interacting with an image generated by light emitting materials 42.

Example FIG. 5 illustrates a graphical user interface 54 and 56 on a steering wheel 50 of an automobile, in accordance with embodiments. Steering wheel 50 may be integrated with the light emitting materials with little or no visual effect in ambient light. The light emitting materials may be selectively excited by light source 12 to generate images 54 and 56 on steering wheel 50. Images 54 and 56 may be a display portion of a graphical user interface, in accordance with embodiments. For example, in example FIG. 5, a graphical user interface asks a user whether to answer a telephone call or not. The user may interact with image 56 by touching “yes” or “no” displayed on the steering wheel 50 by light emitting materials. Proximity sensor 52 may detect the user touching “yes” or “no” and serve as part of a feedback portion of a graphical user interface, in accordance with embodiments. Embodiments are not limited by example FIG. 5.

In embodiments, the uneven surface, the irregular surface, or the random surface is included on a surface of a vehicle and is not limited to steering wheels. For example the surface of the vehicle may be a gage cluster of a vehicle, a transparent cover separated from instruments of the vehicle, a steering wheel, a mirror, a flat panel display, instruments, windows, and/or any other surface of any object (not limited to vehicles) on which light emitting particles can be integrated therein. Embodiments relate to any object which can be integrated with light emitting materials.

There are various approaches to apply the fluorescent component onto an object. For example, it can be dissolved or dispersed in liquid and applied as coatings or it can be integrated into films or sheets and applied onto the object. A dark-light source with lower optical wavelength (e.g. ultraviolet, 200 nm to 500 nm) may be applied to the regions with the fluorescent component and down-converted to a visible or IR image with higher wavelength (e.g. 400 to 2000 nm). In one particular case, the fluorescent coat, film, or sheets is at least partially transparent to visible light, resulting in transparent signage on the object.

The films, coatings, or sheets may contain fluorescent polymers; alternatively, they may be polymers filled/doped with fluorescent materials such as fluorescent dyes, pigments, or phosphor particles. Pure inorganic phosphor films may be directly applied onto an object, while being maintained at least partially transparent. In embodiments, films, coatings, or sheets, may be in the thickness range of 0.01 micron to 2 cm. In some embodiments, the thickness may be in a range of 1 micron to 2 mm. They can be straight or curved into any shape to match that of the substrate. The dyes filler may include pure organic dyes and/or organo-metallic dyes, containing fluorescent organic chromophore group and/or emissive cations such as Eu³⁺, Tb³⁺, that down convert higher wavenumber (or frequency) light to lower wavenumber (or frequency) light on the region with the fluorescent component to plastic covers. The ingredients can also be combined or mixed in either single or multiple layers on an object or substrate.

The fluorescent dyes used in such display may be either pure organic or organo-metallic molecules that emit visible or IR light on excitation of higher energy (or lower wavelength) light, in accordance with embodiments. These dyes may be either be impregnated into plastics or coated onto plastics to turn a layer of plastic (e.g. sheet, film, coating) into fluorescent layers that may be used in the screen of the projective fluorescent displays. Organic molecules or organo-metallic molecules (e.g. organometallic molecules that contain rare earth cations, such as Eu³⁺, Tb³⁺) may emit visible light under darker light (UV-blue) excitation may be applied in the aforementioned fluorescent screens. Pigments or inorganic phosphor particles including fluorescent semiconductor quantum dots may also be used as the fluorescent ingredient in the projective fluorescent display screens. To reduce the light scattering of the inorganic particles on the visible light, which blocks the view of the substrate, the inorganic fluorescent ingredient may be applied with nano-particles in the range of 1 nm to 400 nm (the blue edge of the visible light), or in at least partially transparent thin films, with thickness of 10 nm to 1000 microns, in accordance with embodiments.

Different polymer host or matrix materials may be used as the host matrix and/or the substrate for the fluorescent molecules in forming the fluorescent emissive layer, in accordance with embodiments. Embodiments include at least one of the following polymer components: Classes of polymers include thermosets, thermoplastics, elastomers and inorganics. Certain polymeric alloys, denned as two or more miscible or partially miscible polymers, and/or blends, which may be defined as discrete non-miscible phases. Examples of thermosets and elastomers include polyurethanes, PVB, natural rubber, synthetic rubber, epoxy, phenolic, polyesters, polyamides, and/or silicones. Examples of thermoplastics include polyacetal, polyacrylic, acrylonitrile-butadiene-styrene, polycarbonates, polystyrenes, polyethylene, styrene acrylonitrile, polypropylenes, polyethylene terephthalate, polybutylene terephthalate, nylons (6, 6/6, 6/10, 6/12, 11 or 12), polyamide-imides, polyarylates, polyurethanes, PVB, thermoplastic olefins (e.g. polypropylene/impact modifiers such as ethylene, propylene and rubber), thermoplastic elastomers, polyarylsulfone, polyethersulfone, polyphenylene sulfide, polyvinyl chloride, chlorinated polyvinyl chloride, polysulfone, polyetherimide, polytetrafluoro ethylene, fluorinated ethylene propylene, perfluoroalkoxy, polychlorotrifluoro ethylene, ethylene tetrafluoro ethylene, polyvinylidene fluoride, polyvinyl fluoride, polyetherketone, polyether etherketone and/or polyether ketone ether ketone. Examples of alloys and blends include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, thermoplastic elastomer alloys, nylon/elastomers, polyester/elastomers, polyethylene terephthalate/polybutyl terephthalate, acetal/elastomer, styrene-maleic-anhydride/acrylonitrile-butadiene-styrene, polyether etherketone/polyethersulfone, polyethylene/nylon and/or polyethylene/acetal. Examples of inorganic polymers include phosphorus based compounds and/or silicones.

Besides films, the transparent fluorescent dyes may be applied to a surface in the form of a layer of coating, painting, or inks, in accordance with embodiments. Coating formulations, including solid base (e.g. soluble polymers or polymer precursors), the dyes (or pigments) may be dissolved or blended in solvents to prepare coating/paint formula. Other additives may be dissolved in the solvent to modify the viscosity, flow, leveling, surface tension, optical properties (e.g. gloss) etc. of the coat or paint formula. A fluorescent coating or paint may complement the situation where the dyes are difficult to be impregnated into a plastic film or sheet. A special coating formula with transparent fluorescent ingredient may be applied to the substrate by brushing, spraying, roller, gravure, tape casting, screening printing, or other printing methods, etc, in accordance with embodiments.

In embodiments, to display a multiple color display, multiple colored transparent fluorescent ingredients may be applied to a surface. Depending on the level of the cross-fluorescence on the multiple dyes in the display with the various bands of the dark light from the filter, various structures of the display may be possible. In addition to the fluorescent layer structure for the screen, other functional layers, including protection layers, anti-reflection layer and UV-absorption layers may be combined with such core layer containing fluorescent materials (e.g. dyes or phosphors), in accordance with embodiments. A 3-layered structure for the core layer, corresponding to the emission of 3 prime fluorescent colors (e.g. blue, green, and red) respectively, in accordance with embodiments. The front layers will have minimum absorption on the emission band for back layers, and the front layer may absorb its band of dark light that may also excite the back layers. In embodiments, back layers may be hidden from being crossly excited by the front layer dark light.

A 2-layers structure for the core fluorescent layers. In embodiments, it either contains 2 dyes of different emission colors in the 2 layers, or contain multiple dyes (e.g. green and red) in the single layer that does not cross excite each other with the same waveband of dark light. In embodiments, the front layer facing UV exposure first should not absorb the dark light for the back layer and it may hide the back layer from being excited by the bands of dark light for the front layers. In embodiments, if there is minimum or relatively small cross excitation of various dyes to the various dark light bands, multiple dyes or fluorescent materials may be all put into the same layer of the screen for the simplest structure. In embodiments, the concentration of the dyes in the screen may be adjusted according to the needs for relative fluorescent intensity of various colors from the screen for color balance.

Various colored dyes may be applied, in accordance with embodiments. They include both pure organic dyes and organo-metallic dyes containing color centers such as rare earth cations (e.g. Eu, Tb, Ce) and transitional metals, in accordance with embodiments. In embodiments, dyes may have a minimum absorption in the visible light region, for example in order to minimize the color tinting of the screen and/or to avoid the cross-absorption of fluorescent emission by other dyes in the screen. For example, for red or green dyes, efficient fluorescent dyes with a large Stokes shift may be implemented.

Besides organic or organo-metallic dyes, various inorganic phosphors may also be applied in the core screen to produce multiple color transparent displays, in accordance with embodiments. In embodiments, the particle size is maintained small enough so there is little visible light scattering, which would produce an opaque screen. Accordingly, in embodiments, nanoparticulate of phosphors (e.g. 0.5 nm to 500 nm) ranges may be applied in the screen. In embodiments, quantum dot inorganic nano-particles may be formed by semiconductor compounds, including II-VI compounds.

In embodiments, a fluorescent transparent display may be a static display on a transparent surface, by exposing UV or lower wavelength visible light onto a pattern of fluorescent molecules or nano-particles, for example such as those described above. A pattern may be formed on a transparent screen or panel, by either cutting and/or applying films with fluorescent materials and/or by painting (e.g. by brushing or spraying) liquids containing fluorescent ingredient and/or by printing (e.g. screen printing, ink-jet printing, etc.) liquids containing fluorescent ingredient, in accordance with embodiments. The fluorescent ingredient (e.g. molecules or nanoparticles) may be dissolved or dispersed in film or liquid base before being applied onto a transparent panel or screen to form a substantially transparent pattern. A UV lamp may be a spot lamp projecting onto the panel, it may be tubular gas discharge lamp along the screen or panel, and/or it may be a line or an array of LED lamp lining along the screen or panel. Multiple fluorescent ingredients with different primary emitting colors (e.g. red, green, blue) may be applied in the pattern, which may display a colored fluorescent image on the transparent screen or panel under UV or dark light illumination, in accordance with embodiments. The primary emitting colors may mix on the screen to form many composite display colors.

In embodiments, multiple primary color images may be generated on the display screen or panel containing substantially evenly distributed (e.g. without predefined pattern as in previous embodiment) fluorescent molecules or nano-particles. The emitting primary colors may be mixed to create a color image on the substantially transparent screen or panel. The multiple fluorescent ingredients may be in a single layer on the screen, if there is negligible cross-excitation of the UV-excitation bands with the fluorescent ingredients, or they may be in multiple sequential layers on the screen, to reduce cross-fluorescent excitation, in accordance with embodiments.

Embodiments relate to the application of a layer of substantially visibly transparent layer or coating, which contain fluorescent emissive materials, onto a substrate that can be transparent or opaque. The appearance of the substrate may not be blocked by the visibly transparent layer, which is largely invisible. An optic image with lower wavelength light may be projected to excite the transparent fluorescent layer to display an emissive image.

In embodiments, the fluorescent materials may be organic, organometallic dyes or pigments, and may also be inorganic particles with median particle sizes under 500 nanometers. The fluorescent materials may be dissolved and/or dispersed into a coating liquid prior to be applied to the surface, or it can be extruded or molded into the parts to add an emissive display function. In embodiments, a transparent fluorescent layer may be applied to a flat panel display glass, to allow the use of laser pointer on the flat panel display or TV.

In embodiments, a transparent fluorescent layer or coating may be applied to the transparent cover of the gage cluster of various types of vehicles. A compact projector may be applied onto either side of the cover to show information on the cover, while still allowing driver to read the gage display through the transparent cover, in accordance with embodiments.

In embodiments, a transparent fluorescent layer or coating may be applied to the surfaces of the interiors for various types of vehicles, without hiding the surface appearance. An image projector with lower wavelength (e.g. UV, violet, or blue) may be applied to either side of the coated surface, to excite an image from the transparent emissive layer.

For example, in embodiments, emissive materials may be applied to the surface of a vehicle steering wheel, a front cover of an instrument panel (e.g. on the driver's side or at the central console). A compact digital projector may be used to excite the fluorescent materials to generate a emissive image. The layer of emissive materials may be made substantially transparent so it does not block or affect the original surface appearance of the cover or front panel.

In embodiments, a sensor or camera may be applied to detect input from hand movements and change the projection display image on the surface accordingly, making a transparent interactive emissive display that can be applied to any surface with the fluorescent materials.

Embodiments are not limited to applications for interior surfaces of various vehicles, including cars, trucks, buses, boats, aircrafts, motorcycles, etc. Embodiments relate to displaying images using light emitting materials to turn any surface to an emissive display, with little or no covering or hiding effects on the original appearance of the surface.

In embodiments, to display multiple colors, multiple fluorescent materials emitting different colors under different wavelength or waveband may be used, in layers or mixtures. In embodiments, pixel or spatial color separation may not be needed in the fluorescent layers, projection alignment is not necessary, and embodiments otherwise simplify the use of the emissive displays to any surface.

Although embodiments and their advantages have been described in detail, it should be understood that various changes, substitutions and alterations can be made herein without departing from the spirit and scope of the disclosed as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a light source;
a physical medium; and
light emitting material integrated into at least a portion of the surface of the physical medium,
wherein the light emitting material is configured to emit visible light in response to absorption of at least one of ultraviolet or lower wavelength visible light from the light source,
wherein the light emitting material comprises a plurality of light emitting particles, and
wherein each of the plurality of light emitting particles has a diameter less than about 500 nanometers, and
the surface of the physical medium is an object on which an emissive image can be displayed by the emitted visible light in response to the light source.

2. The system of claim 1, wherein the light source is a laser pointer and the surface is at least a portion of a display device.

3. The system of claim 2, wherein:
the display device outputs an image which is independent of the visible light emitted in response to absorption of light from the laser pointer; and
a user of the laser pointer at least one of annotates, supplements, and highlights the content output from the display device.

4. The system of claim 2, wherein the display device is at least one of:
a flat panel display;
an LCD display;
an OLED display;
a LED display;
a plasma display;
a quantum dot display;
a CRT display;
a television;
a monitor; and
a heads up display.

5. The system of claim 1, wherein:
the surface is at least one of an uneven surface, an irregular surface, or a random surface; and
an image can be displayed on the at least one of the uneven surface, the irregular surface, or the random surface by emitting visible light in response to absorption of light from the light source.

6. The system of claim 5, wherein the at least one of the uneven surface, the irregular surface, or the random surface comprises a surface of a vehicle.

7. The system of claim 6, wherein the surface of the vehicle comprises at least one of:
a gage cluster of a vehicle;
a transparent cover separated from instruments of the vehicle;
a steering wheel;
a mirror;
a flat panel display;
instruments;
interior surfaces;
exterior body panels; and
windows.

8. The system of claim 1, comprising a proximity sensor coupled to the light source to allow feedback from a user movement in relation to the visible light emitted in response to the absorption of light from the light source.

9. The system of claim 1, wherein the visible light emitted in response to absorption of light from the light source comprises a display of a graphical user interface.

10. The system of claim 1, wherein the light source is an ultraviolet projector.

11. The system of claim 1, wherein the light source is a visible light projector.

12. The system of claim 1, wherein the physical medium has at least one of no visible light transmittance characteristics or relatively low visible light transmittance characteristics.

13. The system of claim 12, wherein the physical medium is substantially dark.

14. The system of claim 12, wherein the physical medium is opaque.

15. The system of claim 1, wherein the physical medium has relatively low visible light absorption characteristics.

16. The system of claim 15, wherein the physical medium is substantially transparent.

17. The system of claim 15, wherein the physical medium is reflective.

18. The system of claim 1, wherein the light emitting material comprises at least one of the following fluorescent materials:
inorganic phosphor nanoparticles;
fluorescent quantum dots;
small molecules with organic chromophore;
organic dyes;
organic pigments;
organo-metallic molecules;
polymers; or
oligomers.

19. The system of claim 1, wherein the light emitting material comprises:
a first material which emits a first visible color; and
a second material which emits a second visible color, which is different from the first visible color.

20. The apparatus of claim 19, wherein the light emitting material comprises a third material which emits a third visible color, which is different from the first visible color and the second visible color.
